(19) United States
(12) Patent Application Publication
(10) Pub. No.: US 2005/0272608 A1
(43) Pub. Date: Dec. 8, 2005

(54) Polyimide metal laminate and its production method

(75) Inventors: Shuichi Yokozawa, Sodegaura-shi (JP); Koji Hirota, Sodegaura-shi (JP); Naoki Nakazawa, Nagoya-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: MITSUI CHEMICALS, INC., Minato-ku (JP)

(21) Appl. No.: 11/141,059

(22) Filed: Jun. 1, 2005

Related U.S. Application Data
(60) Provisional application No. 60/607,074, filed on Sep. 3, 2004.

(30) Foreign Application Priority Data
Jun. 8, 2004 (JP) 2004-170093
Sep. 8, 2004 (JP) 2004-260422

(51) Int. Cl. H01B 1/00

(52) U.S. Cl. 505/100

(57) ABSTRACT

A polyimide metal laminate comprising a stainless steel layer/a resin layer/a thermoplastic polyimide resin layer/a metal thin film layer, wherein a thickness of the metal layer is in the range of 0.001 to 1.0 μm, a method for producing the same and a hard disk suspension comprising these polyimide metal laminate are provided. The hard disk suspension can be capable of fine pitch processing such that wiring pitch is not more than 50 μm.

### TECHNICAL FIELD

The present invention relates to a polyimide metal laminate used for a flexible wiring board, a wireless suspension of a hard disk drive or the like. More specifically, the invention relates to a polyimide metal laminate which has sufficient adhesion between a stainless steel foil and a polyimide layer, and a metal thin film and a polyimide layer and which is suitable for high density circuit board materials capable of processing such that an inter-wiring pitch is not more than 50 μm and further not more than 20 μm, and a method for producing the polyimide metal laminate

### BACKGROUND ART

In late years, miniaturization and high performance of a hard disk drive have been rapidly in progress, and a light-weight and miniaturized hard disk suspension has also been in high demand. Plans to respond to these demands have been reviewed. Specifically, such a plan is to develop a wireless suspension with copper wiring formed thereon. A metal laminate comprising a copper alloy/a polyimide resin/SUS304 has been widely used as a material used for the suspension up to now.

In late years, the miniaturization and large-scale integration of the hard disk suspension has been in progress so that a finer line pattern for a flexure has been in progress. However, as the minimum thickness of a copper foil was as thick as about 12 μm in the conventional general hard disk suspension materials, it was difficult to achieve a fine pattern processing such that a wiring pitch was not more than 50 μm pitch. To solve this problem, an ultra thin copper foil having a thickness of 9 μm and improvement of a device handling such a copper foil during processing have recently been in progress. As a result, the copper foil having a thickness of 9 μm has been practically used so that fine pitch wiring processing has been started to deliver a predetermined success.

However, for example, a copper foil of not more than 5 μm necessary for wiring processing of not more than 30 μm pitch has still been in a development stage, which has been a barrier for realizing fine pitch pattern. From such a background, forming a copper thin film of not more than 1 μm according to the sputtering method and a so-called sputter material which is processed in a copper thickness of not more than 10 μm by applying the electrolytic copper plating on the copper thin film, have been paid attention once again. Conventionally, forming such a copper thin film and such a sputter material have been kept at a distance from the viewpoints of the cost restrictions or heat resistance.

Particularly, a copper thin film of not more than 1 μm formed on a polyimide base material according to the sputtering method or the like is considered useful as a material capable of fine pitch wiring processing of not more than 50 μm pitch and further not more than 30 μm pitch according to the additive method. Namely, for example, a dry film resist or a liquid pattern resist is laminated on a copper thin film, and then the above resist is exposed and developed to form a pattern resist. Further, the copper thin film is used as a power supply layer to apply the electrolytic plating with a metal such as nickel, copper or the like. After the cover resist is removed, the unnecessary part of thin metal layer is etched. In this manner, there is a possibility to use such a laminate as a material used for a method for producing electric circuit patterns or parts.

As a method for producing the above metal thin film substrate, for example, in JP1999-348179A (refer to Patent Document 1) has been disclosed a method for producing a metal laminate comprising forming a melt-adhesive layer on the main surface of one side of the heat resistant insulating base material and forming a copper thin film layer on the main surface of the other side by the sputter method, and folding a metal foil on the melt-adhesive layer for heat-pressing. However, in the above patent, as the copper thin film layer and the resin having heat resistance are directly come into contact, and an interface between the copper thin film layer and the heat resistant resin layer is not subjected to any treatment, adhesion in the above interface is not sufficient. Thus, the metal laminate has been deteriorated after heating in some cases. Further, there has been a problem in that, due to a heat-pressing process with the metal foil, the production cost was high.

As a method for processing a metal laminate having a metal thin film to a circuit-fed suspension substrate, for example, in JP2002-57437A (refer to Patent Document 2) has been disclosed a method comprising laminating an insulating resin on a metal substrate and forming a predetermined pattern, then laminating a metal thin film on the insulating layer and the metal substrate by the vacuum deposition method, and subsequently forming a conductor layer in a predetermined pattern by plating on the metal thin film of the insulating resin. However, in this processing step, as a predetermined wiring pattern is formed by etching with a photosensitive resin at first, a single-laminate production is required. So, there have been problems such that processing easily became complicated and the production cost became higher.

Patent Document: 1: JP1999-348179A

Patent Document 2: JP2002-57437A

### DISCLOSURE OF THE INVENTION

An object of the present invention is to provide a polyimide metal laminate in which adhesion between layers is good so that a heat-pressing process is not required, which can be produced by the roll-to-roll process up to the coating process of a photosensitive resin, and enables fine pitch wiring processing in a much simpler and cheaper production method.

The present inventors have conducted an extensive study and as a result, have found that a polyimide metal laminate comprising a stainless steel layer/a resin layer/a thermoplastic polyimide resin layer/a metal thin film layer, in which a stainless steel-polyimide laminate is formed by laminating a thermoplastic polyimide resin layer as an outermost layer on the stainless steel layer and a metal thin film layer in a specific range of the thickness is preferably formed on the thermoplastic polyimide resin layer according to the sputtering method, has sufficient adhesion between the metal thin film layer and the polyimide resin, and a circuit capable of high density can be formed with cheaper cost by forming, in the processing step, a photosensitive resin layer on the metal thin film layer to form a predetermined pattern and then applying copper plating with a sputter layer as a power supply layer. Thus, the present invention has been completed.

That is, the present invention relates to a polyimide metal laminate comprising a stainless steel layer/a resin layer/a thermoplastic polyimide resin layer/a metal thin film layer, wherein a thickness of the metal thin film layer is in the range of 0.001 to 1.0 μm, the metal thin film layer is preferably formed according to the sputtering method, the metal thin film layer is more preferably a metal thin film comprising copper or a copper alloy, and the thermoplastic polyimide resin layer adjacent to the metal thin film layer is further preferably a thermoplastic polyimide resin obtained by polymerizing at least one kind of diamine selected from a group comprising 1,3-bis(3-aminophenoxy)benzene, 4,4′-bis(3-aminophoxy)biphenyl, 3,3′-diaminobenzophenone and 2,2-bis[4-(4-aminophenoxy)]phenylpropane with at least one kind of tetracarboxylic acid dianhydride selected from a group comprising 3,3′,4,4′-benzophenone tetracarboxylic acid dianhydride, 3,3′,4,4′-diphenylether tetracarboxylic acid dianhydride, pyromellitic acid dianhydride, 3,3′,4,4′-biphenyl tetracarboxylic acid dianhydride and diphenylsulfon tetracarboxylic acid dianhydride.

Furthermore, the present invention also provides a hard disk suspension, on which a circuit is formed by further forming a photosensitive resin layer on a metal thin film layer of the polyimide metal laminate, etching the above photosensitive resin in a predetermined pattern and then plating on the metal thin film layer, and a method for producing the hard disk suspension.

### BEST MODE FOR CARRYING OUT THE INVENTION

The polyimide metal laminate and the method for producing the polyimide metal laminate of the present invention are explained in detail below.

The present invention relates to a polyimide metal laminate comprising a stainless steel layer/a resin layer/a thermoplastic polyimide resin layer/a metal thin film layer, wherein a thickness of the metal thin film layer is from 0.001 to 1.0 μm.

The metal thin film layer is preferable when its thickness is within the above range, as it is possible to achieve fine pitch processing of not more than 50 μm pitch and further not more than 30 μm pitch according to the semi-additive method. The thickness of the metal thin film layer is preferably from 0.01 to 0.5 μm, more preferably from 0.05 to 0.5 μm and further preferably from 0.1 to 0.5 μm. The metal thin film layer is used as a power supply layer for applying electrolytic plating or as an under layer at the time of electroless plating, when forming a fine pattern by the additive method. Therefore, within this range, electrical conductivity can be preferably secured.

In the polyimide metal laminate of the present invention, the metal thin film layer is preferably formed by the sputtering method in consideration of adhesion between the metal thin film layer and the thermoplastic polyimide resin layer as an outermost layer or easiness of the film formation. Furthermore, concrete examples of the sputtering method include, though not particularly restricted to, various methods such as DC sputter, RF sputter, DC magnetron sputter, RF magnetron sputter, ECR sputter, laser beam sputter and the like, which can be properly used as required. The DC magnetron sputter method is particularly more preferable as the cost is low and a metal layer can be easily formed.

The film-forming conditions of the metal thin film layer according to the magnetron sputter method are exemplified below. There can be exemplified a method under conditions that argon gas is used as the sputter gas, the pressure is preferably from 1×10⁻² to 1 Pa, more preferably from 7×10⁻² to 7×10⁻¹ Pa and further preferably from 1×10⁻¹ to 4×10⁻¹ Pa, and a sputter power density is preferably from 1 to 100 Wcm⁻², more preferably from 1 to 50 Wcm⁻² and further preferably from 1 to 20 Wcm⁻². In order to control the thickness when forming a film of the metal thin film layer according to the magnetron sputter method, a film-forming rate is determined in advance and the time required for film forming is then managed.

In the polyimide metal laminate of the present invention, examples of the metal types for the metal thin film layer include, though not particularly restricted to, copper, nickel, silver and alloys thereof and the like. Preferred examples thereof include copper or copper alloys.

In the present invention, in order to improve adhesive strength between the thermoplastic polyimide resin layer and the metal thin film layer or heat resistance, it is preferable to further form an adhesive layer between the polyimide resin layer and the metal thin film layer. Furthermore, it is also preferable to use known techniques for the modification of a surface of the polyimide resin layer such that a surface of the thermoplastic polyimide resin layer adjacent to the metal thin film layer is exposed to corona discharge, plasma or ultraviolet rays, or immersed in an alkali etching solution, a silane coupling material or a special polymer is used, or the like. As the above surface modification method, exposing the surface of the thermoplastic resin as an outermost layer of the polyimide resin layer to plasma is simply realizable and effective.

Incidentally, plasma can be generated by applying dc or ac voltage to an electrode for generating plasma. In particular, exposing to plasma containing oxygen is very effective. As gas used for generating plasma containing the oxygen, there can be exemplified, for example, oxygen, gas containing oxygen such as nitrous oxide, carbon monoxide, carbon dioxide and the like in a molecule, a mixed gas with oxygen represented by air, a mixed gas of a gas for etching such as nitrogen trifluoride, carbon fluoride and the like with oxygen, a mixed gas of a gas containing nitrogen such as nitrogen, ammonia and the like with oxygen, or the like. Such gases can be properly selected. In these mixed gases, the content of the gas other than oxygen added to oxygen is not particularly restricted, but it is preferably in the range of 0 to 70%. Further, the gas used for the mixture may be used singly or may be a mixed gas with 2 or more kinds.

As a material which can be used for the adhesive layer between the thermoplastic polyimide resin layer and the metal thin film layer, there can be exemplified, for example, metals such as titanium, vanadium, cobalt, nickel, zinc, tungsten, molybdenum, zirconium, tantalum, tin, indium and the like, or alloys containing one or more metals selected from these groups, and heat resistant alloys such as monel, nichrome, inconel and the like. Furthermore, oxides, nitrides, carbides, phosphorous compounds of the above metals, complex oxides of the above metals such as indium tin oxides (ITO), zinc chromate and the like can also be used as the adhesive layer.

The thickness of the adhesive layer is preferably from 5 to 50 nm and more preferably from 5 to 20 nm. Within this range, it is considered that there is an effect of improving adhesive strength between the polyimide resin layer and the metal layer.

The stainless steel layer, a constituent element of the polyimide metal laminate of the present invention, is not particularly restricted as far as it is made up of stainless steel. However, a preferred one is SUS304 from the viewpoints of stiffness properties or dimensional stability necessary for suspension and a more preferred one is SUS304 which is subjected to a tension annealing process at a temperature of not less than 300° C. A preferred thickness of the stainless steel layer is from 10 to 70 μm and more preferably from 15 to 30 μm.

In the polyimide metal laminate of the present invention, the polyimide resin layer is not particularly restricted except for the thermoplastic polyimide resin layer adjacent to the metal thin film layer and known resin layers can be used for the resin layer adjacent to the stainless steel foil. The resin layer more preferably comprises a thermoplastic polyimide layer as an outermost layer to form a three-layered structure having a thermoplastic polyimide resin layer/a non-thermoplastic polyimide resin layer/a thermoplastic polyimide resin layer.

As the non-thermoplastic polyimide resin which can be used when the resin layer between the stainless steel layer and the metal thin film layer in the present invention is in a three-layered structure having a thermoplastic polyimide resin layer/a non-thermoplastic polyimide resin layer/a thermoplastic polyimide resin layer, polyimide or filler-containing polyimide is preferable, considering that heat resistance is one of major items in using the laminate of the present invention in many cases. As concrete commercial products which can be used, there can be exemplified, for example, KAPTON (registered trademark) SuperV, KAPTON (registered trademark) V, KAPTON (registered trademark) E, KAPTON (registered trademark) EN and KAPTON (registered trademark) H, manufactured by Du Pont-Toray Co., Ltd., UPILEX (registered trademark) S and UPILEX (registered trademark) SGA, manufactured by UBE Industries, Ltd., APICAL (registered trademark) AH, APICAL (registered trademark) NPI and APICAL (registered trademark) HP, manufactured by Kaneka Corporation, and the like. These can be easily available on the market and can be properly used for the present invention. Incidentally, the non-thermoplastic polyimide resin in the present invention refers to a polymer having an imide structure on its main chain, without having any glass transition temperature or having a glass transition temperature of not less than 350° C. and without extremely reducing the elastic modulus in this temperature range.

Furthermore, a polyimide to be formed by directly imidizing an acid dianhydride with diamine can also be used. As for the acid dianhydride, there can be exemplified, for example, pyromellitic acid dianhydride, biphthalic acid dianhydride, benzophenone tetracarboxylic acid dianhydride, oxydiphthalic acid dianhydride, hydrofuran diphthalic acid dianhydride and the like.

On the other hand, diamine as a raw material, there can be exemplified, for example, methoxy diaminobenzene, 4,4′-oxydianiline, 3,4′-oxydianiline, 3,3′-oxydianiline, bisdianilinomethane, 3,3′-diaminobenzophenone, p,p-aminophenoxybenzene, p,m-aminophenoxybenzene, m,m-aminophenoxybenzene, chloro-m-aminophenoxybenzene, p-pyridineaminophenoxybenzene, m-pyridineaminophenoxybenzene, p-aminophenoxybiphenyl, m-aminophenoxybiphenyl, p-bisaminophenoxybenzylsulfon, m-bisaminophenoxybenzylsulfon, p-bisaminophenoxybenzylketone, m-bisaminophenoxybenzylketone, p-bisaminophenoxybenzylhexafluoropropane, m-bisaminophenoxybenzylhexafluoropropane, m-bisaminophenoxybenzylhexafluoropropane, p-bisaminophenoxybenzylpropane, o-bisaminophenoxybenzylpropane, m-bisaminophenoxybenzylpropane, p-diaminophenoxybenzylthioether, m-diaminophenoxybenzylthioether, indane diamine, spirobi diamine, diketone diamine, m-tolidine and the like.

The thickness of the non-thermoplastic polyimide resin is not particularly restricted, but it is preferably from 3.0 to 150 μm, more preferably from 3.0 to 100 μm and further preferably from 5.0 to 75 μm.

The thermoplastic polyimide resin adjacent to the metal thin film layer in the present invention is a polymer having an imide structure on its main chain. It is not particularly restricted as far as its glass transition temperature is preferably in the range of 150 to 350° C. and the elastic modulus in this temperature range is extremely reduced. Incidentally, the thermoplastic polyimide resin in the present invention refers to a polymer having an imide structure on its main chain, having a glass transition temperature in the range of 150 to 350° C. and extremely reducing the elastic modulus in this temperature range.

Concrete examples of the thermoplastic polyimide resin layer include a thermoplastic polyimide resin preferably obtained by polymerizing at least one kind of diamine selected from a group comprising 1,3-bis(3-aminophenoxy)benzene, 4,4′-bis(3-aminophenoxy)biphenyl, 3,3′-diaminobenzophenone and 2,2-bis[4-(4-aminophenoxy)]phenylpropane with at least one kind of tetracarboxylic acid dianhydride selected from a group comprising 3,3′,4,4′-benzophenone tetracarboxylic acid dianhydride, 3,3′,4,4′-diphenylether tetracarboxylic acid dianhydride, pyromellitic acid dianhydride, 3,3′,4,4′-biphenyl tetracarboxylic acid dianhydride and diphenylsulfon tetracarboxylic acid dianhydride. Further, commercial products can also be used. Examples thereof include Larc-TPI (a product of Mitsui Chemicals, Inc.) and the like.

Furthermore, when the thermoplastic polyimide resin is used as a resin layer adjacent to a stainless steel foil, its composition may be the same as or different from that of the thermoplastic polyimide resin adjacent to the metal thin film layer. Specifically, the above thermoplastic polyimide resin can be cited.

The thickness of the thermoplastic polyimide resin layer in the present invention is not particularly restricted, but it is preferably from about 0.1 to 10 μm and more preferably from about 0.3 to 5 μm. Particularly, the thickness of a thermoplastic polyimide resin next to a stainless steal foil affects the adhesion between the polyimide resin and stainless steel. The favorable thickness of a thermoplastic polyimide resin is 0.1 to 2.0 μm.

In the present invention, the hard disk suspension can also be produced by further forming a photosensitive resin layer on the metal layer of the polyimide metal laminate in a structure of a stainless steel layer/a resin layer/a thermoplastic polyimide resin layer/a metal thin film layer and processing it.

As the photosensitive resin which can be used at that time, there can be exemplified, for example, a polyimide resin, an epoxy resin, an acrylic resin and the like showing photosensitivity. The photosensitive resin is preferably selected from at least one of the above resins. As the photosensitive resin to be used for the base material, a photosensitive resin in an arbitrary structure can be selected. The arbitrary structure can be negative or positive. Usually, the photosensitive resin may be ultraviolet ray responsive, electron beam responsive or the like. It is generally made up of a reactive monomer, a reactive oligomer, a reactive diluent, a photo initiator, a sensitizer and the like. As the reactive oligomer, there can be exemplified, for example, epoxy acrylate, urethane acrylate, polyester acrylate and the like. As the photosensitive resin, a UV curing type acrylic resin is particularly preferable from the viewpoints of anti-alkaline property and water resistant permeability while etching a polyimide precursor resin layer.

The thickness of the photosensitive resin layer is not particularly restricted, but it is preferably from 2 to 100 μm. When the thickness is thinner than 2 μm, the processing accuracy is high, but the film strength might be insufficient so that peeling might occur while in development of the photosensitive resin or while etching the polyimide precursor resin layer. Further, when the thickness exceeds 100 μm, the film strength is great, resulting in increasing reliability, but the processing accuracy might be worsened and the economic efficiency tends to be reduced.

The whole base material is coated on the metal thin film with the above photosensitive resin in a method such as spin coat, curtain coat, dip coat and the like preferably in a thickness of from 5 to 40 μm. Subsequently, the metal thin film is preferably dried under a nitrogen atmosphere of from 70 to 90° C. for 10 to 30 minutes. Then, ultraviolet rays are irradiated through a photo-mask in which a desired pattern is drawn for exposure. Exposure is normally carried out in an exposure amount of from about 100 to 800 mJ/cm². Next, the development of the resist is carried out using a developing solution. To develop, a dipping method, an ultrasonic method, a spraying method and the like can be used. In order for fine pattern processing, the ultrasonic developing method is preferable. The ultrasonic development is used at 25° C. for about 10 minutes. With the metal thin film layer, i.e., an exposed portion of a patterned base material as a seed layer, a circuit is formed by copper plating. As a method for plating, electrolytic plating or electroless plating can be cited. In this case, the metal thin film is plated so that the electrolytic plating is preferable as it is much simpler and it takes a shorter period of time. After forming a circuit on the metal thin film by the electrolytic plating, the hard disk suspension base material having a circuit formed thereon can be obtained by removing the unnecessary portion of the photosensitive polyimide resin.

The polyimide metal laminate of the present invention can be produced by a method comprising coating the stainless steel foil with a precursor varnish comprising a resin layer and drying, then coating it with a thermoplastic polyimide resin precursor varnish and drying to form a polyimide metal laminate comprising a thermoplastic polyimide resin layer as its outermost layer on the stainless steel foil and to form a metal thin film layer on the above thermoplastic polyimide resin. As a more specific and preferred method, first the stainless steel foil is coated with a thermoplastic polyimide resin precursor varnish and dried, then coated with a non-thermoplastic polyimide resin precursor varnish and a thermoplastic polyimide resin precursor varnish and dried in sequence to form a three-layered polyimide resin layer on the stainless steel foil. At that time, the varnish is a solution obtained by polymerizing the above specific diamine with the tetracarboxylic acid dianhydride in a solvent. As a method for coating directly on the stainless steel foil, known methods such as a die coater, a comma coater, a roll coater, a gravure coater, a curtain coater, a spray coater and the like can be used. The coating thickness can be selected according to the varnish or the like. A preferred thickness is the same as described above.

As a method for drying and curing the coating varnish, a usual heating and drying oven can be used. As the atmosphere of the drying oven, air, inert gas (nitrogen and argon) and the like can be used. A temperature for drying is properly selected according to the boiling point of a solvent, but it is preferably in the range of 60 to 600° C. The time required for drying is properly selected by the thickness, density and the type of a solvent, but it is preferably from about 0.5 to 500 minutes. In the range of the thickness specified by the present invention, the metal thin film layer is preferably formed according to the above sputtering method on the side of the polyimide resin of the stainless steel-polyimide laminate produced by the above method, whereby the polyimide metal laminate of the present invention can be produced.

By processing the polyimide metal laminate of the present invention, a hard disk suspension material which is excellent in fine pitch pattern can be produced. As an example of a method for producing a hard disk suspension, the above resist with a dry film resist or a liquid pattern resist laminated on the metal thin film of the polyimide metal laminate of the present invention is exposed and developed for forming a pattern resist. Furthermore, the metal thin film is used as a power supply layer, a metal such as nickel, copper or the like is used for the electrolytic plating. After the resist film is removed, the unnecessary part of the thin metal film is etched. In this manner, a hard disk suspension material having fine wiring pitch can be produced.

### EXAMPLES

The present invention is now more specifically illustrated below with reference to Examples. However, the present invention is not limited to these Examples.

Abbreviations for solvents, acid dianhydrides and diamines used for Examples are described below.

DMAc: N,N′-dimethylacetamide

APB: 1,3-bis(3-aminophenoxy)benzene

PMDA: pyromellitic acid dianhydride

PPD: para-phenylene diamine

BPDA: 3,3′,4,4′-biphenyl tetracarboxylic acid dianhydride

BTDA: 3,3′,4,4′-benzophenone tetracarboxylic acid dianhydride

m-BP: 4,4′-bis(3-aminophenoxy)biphenyl

ODA: 4,4′-diaminodiphenylether

### Synthesis Example 1

<Synthesis of a Non-Thermoplastic Polyimide Precursor>

7.7 mole of PPD was weighed as a diamine component, and 5.4 mole of BPDA and 2.25 mole of PMDA were weighed as tetracarboxylic acid dianhydride components. These components were dissolved in DMAc for mixing. The reaction temperature was 23° C. and it took 6 hours for the reaction. Further, the density of a solid content at the reaction was 20 weight %. The viscosity of the obtained polyamic acid varnish was 30,000 cps at 25° C., which was appropriate for coating.

### Synthesis Example 2

<Synthesis of a Non-Thermoplastic Polyimide Precursor>

2.3 mole of m-BP and 5.4 mole of ODA were weighed as diamine components, and 7.5 mole of PMDA was weighed as a tetracarboxylic acid dianhydride component. These components were dissolved in DMAc for mixing. The reaction temperature was 23° C. and it took 6 hours for the reaction. Further, the density of a solid content at the reaction was 20 weight %. The viscosity of the obtained polyamic acid varnish was 20,000 cps at 25° C., which was appropriate for coating.

### Synthesis Example 3

Polyamic acids of Synthesis Examples 1 and 2 were mixed in a ratio of 77:23 to obtain a non-thermoplastic polyimide precursor.

### Synthesis Example 4

<Synthesis of a Thermoplastic Polyimide Precursor>

0.10 mole of tetracarboxylic acid anhydride BTDA and 0.10 mole of diamine APB were put into a 1000 cm³ separable flask and dissolved in 622 g of DMAc under a nitrogen atmosphere. The resulting solution was stirred for 15 hours to obtain a polyamic acid varnish. Further, the density of a solid content at the reaction was 10%.

### Example 1

<Production of a Polyimide Metal Laminate>

A stainless steel foil (product name: SUS304H-TA, thickness: 20 μm, manufactured by Nippon Steel Corporation) was coated with [Larc-TPI] (a product of Mitsui Chemicals, Inc.) as a thermoplastic polyamic acid varnish using a roll coater (a product of Inoue Metalworking Industry Co., Ltd.) such that the thickness of the varnish after drying was 0.5 μm and then the this laminate was dried at 180° C. for 10 minutes. The polyimide resin layer of the this laminate was further coated with the non-thermoplastic polyamic acid varnish prepared in Synthesis Example 3 at a thickness of 8.0 μm and dried under the above conditions. Furthermore, thereon was further coated with the thermoplastic polyamic acid varnish prepared in Synthesis Example 4 at a thickness of 2.0 μm and dried under the above conditions to obtain a polyimide metal laminate having a polyimide resin formed thereon in a three-layered structure on the stainless steel foil. The laminate was cured in an inert oven (a product of Yamato Scientific Co., Ltd.) at a temperature programming rate of 5° C./min up to 100 to 300° C.

<Formation of a Metal Thin Film Layer According to the Sputtering Method>

After curing, the polyimide metal laminate was cut into 8 cm×8 cm square and to form a metal thin film layer, a magnetron sputter device (a product of Tokuda Co., Ltd.) capable of attaching two or more sputter targets having a diameter of 125 cm and a thickness of 5 mm was used. After setting it to the substrate holder of the sputter device, pre-vacuuming was carried out up to the pressure of not more than 10⁻³ Pa. A plasma treatment (RF glow discharge treatment) of the thermoplastic polyimide resin was carried out under the conditions of the oxygen gas flow rate of 100 SCCM, the pressure of 1.3 Pa, the RF power of 100 W and the treatment time of 3 minutes. It took 40 seconds for forming a film using a monel target (purity of 99.9%) under the conditions of the argon flow rate of 15 SCCM, the pressure of 0.13 Pa and DC of 160 W to form a film of the monel layer having a thickness of 10 nm on the thermoplastic polyimide layer. Here, the plasma treatment of the thermoplastic polyimide and application of the monel layer were carried out to enhance adhesion between the thermoplastic polyimide and copper of the metal layer. Furthermore, it took 18 minutes for forming a film using a copper target (purity of 99.99%) under the conditions of the argon flow rate of 15 SCCM, the pressure of 0.13 Pa and DC of 180 W so that copper of the metal thin film layer was film-formed at a thickness of 250 nm to obtain a polyimide metal laminate.

<Measurement of Adhesion Between the Metal Thin Film and Polyimide Resin>

After the appropriate sample was degreased using an acid, the copper was laminated on the sample at a thickness of 28 μm by carrying out plating in a copper sulfate aqueous solution two times under the power density of 1.4 A/dm² and washing out acidity. A 3.2 mm wide IC tape (a product of Izumiya IC Inc.) for an etching protecting film was attached to the electrolytic plated side of the sample which was then etched with an iron (II) chloride etching solution to form a 3.2 mm wide copper line. The copper line was measured for the peel strength by a tensile tester (STROGRAPH-M1, manufactured by Toyo Seiki Co., Ltd.).

Incidentally, as for the heating deterioration of the peel strength, the peel strength was measured after patterning the plated copper in a width of 3.2 mm and exposing the plated copper under an environment of 150° atmosphere using an inert oven (a product of Yamato Scientific Co., Ltd.).

### Example 2

<Formation of Wiring>

The stainless steel foil/thermoplastic polyimide resin layer/non-thermoplastic polyimide resin layer/thermoplastic polyimide resin layer/metal thin film layer obtained in Example 1 was cut at 10 square-cm and a masking film was attached to the stainless steel foil. The metal thin film side of the base material was coated with a positive-type resist solution (a product of Tokyo Ohka Kogyo Co., Ltd.) using an immersion coating device and then dried in an oven at 100° C. for 10 minutes. After drying, the masking film was peeled off and a photo-mask having five wiring patterns of L/S=20/20 was put on the positive-type resist, which was then irradiated with ultraviolet rays under the condition of 800 mJ/cm² using an exposure system (HMW401B, manufactured by ORC Manufacturing Co., Ltd.). After exposure, the pattern was developed using a developing solution at 50° C. for 3 minutes and dried using an oven (a product of Yamato Seiki Co., Ltd.). With the metal thin film exposed portion of the base material as a power supply layer, electrolytic plating was applied by copper sulfate in the same manner as in Example 1 to form a circuit having a power density of 1.2 μm and a thickness of 8 μm.

<Observation of Wiring>

5 line widths of the sample having wiring formed thereon and 4 inter-wiring widths were observed at magnifications of 250, 500 and 1,250 times using an optical microscope (VF7510, manufactured by Keyence Corporation). At that time, 10 points of wiring widths and inter-wiring widths were respectively measured and each average was taken for a wiring width and an inter-wiring width. The wiring width and inter-wiring width formed in a range of 20 μm±5 were taken for good fine processing, whereas the wiring width and inter-wiring width out of that range were taken for bad processing.

### Comparative Example 1

<Production of a Polyimide Metal Laminate>

A stainless steel foil (product name: SUS304H-TA, thickness: 20 μm, manufactured by Nippon Steel Corporation) was coated with [Larc-TPI] (a product of Mitsui Chemicals, Inc.) as a thermoplastic polyamic acid varnish using a roll coater (a product of Inoue Metalworking Industry Co., Ltd.) such that the thickness of the varnish after drying was 0.5 μm and then the this laminate was dried at 180° C. for 10 minutes. The polyimide resin layer of this laminate was further coated with the non-thermoplastic polyamic acid varnish prepared in Synthesis Example 3 at a thickness of 8.0 μm and dried under the above conditions. In this manner, a polyimide metal laminate having a polyimide resin in a two-layered structure formed on the stainless steel foil was obtained. The laminate was cured in an inert oven (a product of Yamato Scientific Co., Ltd.) at a temperature programming rate of 5° C./min up to 100 to 300° C.

<Formation of a Metal Layer by Heat-Pressing>

A metal thin film having a thickness of 250 nm was formed on a non-thermoplastic resin under the same conditions as in Example 1 to obtain a polyimide metal laminate.

<Measurement of Adhesion Between a Metal Thin Film and a Polyimide Resin>

Adhesion was measured in the same manner as in Example 1.

### Comparative Example 2

<Formation of Wiring>

In general, wiring was formed on a copper clad laminate comprising a stainless steel foil 20 μm/a polyimide resin 18 μm/a copper foil 18 μm used as a hard disk suspension material using a conventional production method of the subtractive process. Specifically, first a sample was cut at 10-square cm and a photosensitive resin layer was formed on the copper foil layer in the same manner as in Example 2 to obtain a predetermined pattern. Subsequently, after removing the copper foil layer of the exposed portion by etching with iron (II) chloride aqueous solution to form wiring, the unnecessary photosensitive resin was removed at 60° C. for 5 minutes using developing solution.

<Observation of Wiring>

Wiring was observed in the same manner in Example 2.

TABLE 1

| | | | | Comparative |
|---|---|---|---|---|
| | | | Example 1 | Example 1 |
| Peel | Metal Thin | Room Temperature | 0.84 | 0.64 |
| Strength | Film/Polyimide | After Heating | 0.68 | 0.30 |
| kN/m | Stainless steel/ | Room Temperature | 1.05 | 1.12 |
| | Polyimide | | | |

TABLE 2

| | | Wiring 1 | Inter-wiring 1 | Wiring 2 | Inter-wiring 2 | Wiring 3 | Inter-wiring 3 | Wiring 4 | Inter-wiring 4 | Wiring 5 |
|---|---|---|---|---|---|---|---|---|---|---|
| Example 2 | Wiring | 19.2 | 21.1 | 20.2 | 19.5 | 20.9 | 19.3 | 20.5 | 20.4 | 20.8 |
| | width | | | | | | | | | |
| | Result | good | good | good | good | good | good | good | good | good |
| Comparative | Wiring | 38.5 | 10.2 | 41.6 | 9.8 | 40.5 | 10.2 | 41.2 | 8.9 | 40.7 |
| Example 2 | width | | | | | | | | | |
| | Result | bad | bad | bad | bad | bad | bad | bad | bad | bad |

### INDUSTRIAL APPLICABILITY

According to the present invention, it is possible to produce a stainless steel foil/a resin layer/a thermoplastic polyimide resin layer/a metal thin film layer which can be easily processed and has a good adhesion between each layer. The present invention provides a hard disk suspension material capable of fine pitch pattern with much cheaper cost by forming a photosensitive resin layer on a metal layer.

1. A polyimide metal laminate comprising a stainless steel layer/a resin layer/a thermoplastic polyimide resin layer/a metal thin film layer, wherein a thickness of the metal thin film layer is in the range of 0.001 to 1.0 μm.

2. The polyimide metal laminate according to claim 1, wherein the metal thin film layer is formed with the sputtering method.

3. The polyimide metal laminate according to claim 1, wherein the metal thin film layer is a copper thin film or a copper alloy thin film.

4. The metal laminate according to claim 1, wherein the thermoplastic polyimide resin layer adjacent to the metal thin film layer is a thermoplastic polyimide resin obtained by polymerizing at least one kind of diamine selected from a group comprising 1,3-bis(3-aminophenoxy)benzene, 4.4′-bis(3-aminophenoxy)biphenyl, 3,3′-diaminobenzophenone and 2,2-bis[4-(4-aminophenoxy)]phenylpropane with at least one kind of tetracarboxylic acid dianhydride selected from a group comprising 3,3′,4,4′-benzophenone tetracarboxylic acid dianhydride, 3,3′,4,4′-diphenylether tetracarboxylic acid dianhydride, pyromellitic acid dianhydride, 3,3′,4,4′-diphenyl tetracarboxylic acid dianhydride and diphenylsulfone tetracarboxylic acid dianhydride.

5. The metal laminate according to claim 1, wherein the resin layer formed by coming into contact with the stainless steel layer is made up of a thermoplastic polyimide resin layer and a non-thermoplastic polyimide resin layer.

6. A method for producing the polyimide metal laminate as described in claim 1, wherein a polyimide metal laminate comprising a thermoplastic polyimide resin layer as its outermost layer is formed on the stainless steel foil by coating the stainless steel foil with a thermoplastic polyimide resin precursor varnish and drying, and then coating it with a precursor varnish comprising a resin layer and drying, and a metal thin film layer is formed on the thermoplastic polyimide resin.

7. A hard disk suspension obtained by processing the polyimide metal laminate as described in claim 5.

8. A hard disk suspension obtained by processing the polyimide metal laminate as described in claim 1.

9. A hard disk suspension obtained by processing the polyimide metal laminate as described in claim 2.

10. A hard disk suspension obtained by processing the polyimide metal laminate as described in claim 3.

11. A hard disk suspension obtained by processing the polyimide metal laminate as described in claim 4.
